(19) United States
(12) Patent Application Publication
(10) Pub. No.: US 2021/0332534 A1
(43) Pub. Date: Oct. 28, 2021

(54) Tufted Geotextile With Intermediate Diverter Tufts For Increased Resistance To Infill Displacement

(71) Applicant: Watershed Geosynthetics LLC, Alpharetta, GA (US)

(72) Inventors: Jose L. Urrutia, Suwanee, GA (US); S. Kyle Ehman, Milton, GA (US); Michael R. Ayers, Johns Creek, GA (US)

(73) Assignee: Watershed Geosynthetics LLC, Alpharetta, GA (US)

(21) Appl. No.: 16/856,504

(22) Filed: Apr. 23, 2020

(51) Int. Cl. E01C 13/08; D05C 17/02; B09B 1/00

(52) U.S. Cl. CPC E01C 13/08; D05C 17/026; D10B 2505/202; D10B 2505/204; B09B 1/004

(57) ABSTRACT

A tufted geotextile cover system, comprising a backing sheet tufted with first tuft lines of tufts on a first spacing and second transverse tuft lines of tufts on a second spacing greater than the first spacing to dispose the second tufts intermediate opposing pairs of the first tuft lines that define interstices for receiving infill, the tufts in the second tuft lines increasing resistance of the infill to displacement and dry flow movement in response to loading on the geotextile overlying a surface for covering a ground site. A closure system is disclosed using the tufted geotextile as a component overlying an impermeable geomembrane for resisting inflow of water below the ground surface.

### TECHNICAL FIELD

The present invention relates to geotextile sheets for covering waste site and land site surfaces. More particularly, the present invention relates to geotextile sheets having spaced-apart lines of tufts in interstices that receive infill and with intermediate diverter tufts that increase infill stability by shear resistance to infill displacement or granular flow from loading such as from hydraulic flow, wind, seismic and subgrade materials vibrations, expansion and contraction loading, and the like other loading forces directed onto a ground cover system.

In this application, the following terms will be understood to have the indicated definitions:

waste sites—refers to earthen berms or piles and to sites where waste is deposited, such as landfills, phosphogypsum stacks, environmentally impacted land, leach pads, mining spoils and environmental closures or material stockpiles that require a closure or cover system to protect proximate and remote environments such as local subsurface ground and ground water table and downstream waterways and bodies and subsurface ground;

synthetic grass—refers to a composite of at least one geotextile (woven or nonwoven) tufted or knitted with one or more synthetic yarns or strands that has the appearance of grass;

geomembrane—refers to a conventional structured or textured (surface treatment or extending projections) polymeric-material sheets, such as high density polyethylene, very low density polyethylene, linear low density polyethylene, polyvinyl chloride, etc, provided as an impermeable sheet for liner purposes in the waste site and land site industry;

granular flow—displacement with fluid characteristics of a hard granular material; fluidal displacement or movement of a granular material caused by loading forces on the granular material; for example, movement of sand within an hour glass, movement of granular infill in a tufted geotextile application.

geotextile—refers to a flexible material consisting of a network of natural or artificial fibers for ground covering purposes; and

stitching pattern geosynthetic—refers to any tufted, knitted, woven, air-laid, non-woven, crocheted, knotted, felted, braided or fabric geotextile with a structured stitching pattern of grass-like blades extending from an upper surface providing increased resistance to infill displacement.

### BACKGROUND OF THE INVENTION

Large area land sites occupied for use as waste sites, landfills, stockpiles, and power plant disposal fields remain open typically for a number of years for receiving waste materials, mining spoils or power plant wastes and ash, landfill trash and municipal solids and liquids wastes. Waste sites typically have steep slopes rising from a toe or base to an upper elevated apex or peak. The elevation over time with deposits of fill materials may typically reach several hundred feet above the toe. While steep slopes allow increased storage volume, steep slopes experience significantly high shear forces. These forces occur in response to the fill materials loaded within a vertical portion of the area allocated for the landfill and also arise from precipitation and water flow such as from rain fall on the waste site that generates high volumes of water flowing downwardly to the toe. Steep slopes often experience large and rapid water run-off. Upon reaching an appropriate capacity for the particular site, the site is closed to receiving additional waste materials. In the interim, however, filled portions of large area land sites may gainfully use a covering to reduce or, with an impermeable component in a covering system to block, water inflow into the land site and to reduce disturbances of the in-fill materials pending closure. Some such temporary coverings may require ten or more years expected longevity. Such covering may also be gainfully applied for long term final covering systems.

The structure of landfills and waste sites are subject to environmental regulations for construction, operation, and closing after design capacity is reached. Construction regulations routinely require lining of a base of landfill with an impermeable geomembrane liner. The liner restricts flow of water and contaminates from the fill material and precipitation into ground water below the landfill. Rather, water is channeled to a liquids treatment facility prior to discharge. For the case of top closure liners, the geomembrane however may slip or move in response to shear forces, and slippage may cause damage to the geomembrane as well as site failure and avalanche-type sliding collapse of the fill material. Such failure and damage incurs significant cost to remedy particular if the failure causes openings in the liner which then must be replaced in order to maintain impermeability of the closure site.

Land site filling operations typically involve depositing waste materials in specific laydown areas. The deposited waste materials are often covered with a soil layer to form a cell. Adjacent cells are formed with subsequently deposited waste materials. Closure of the site upon reaching design capacity involves overlaying a covering of sealing materials on exposed surfaces of the landfill. Notwithstanding closure, the land sites have ongoing costs including monitoring for leaching of wastes and contaminates into water systems and streams, collection and discharge of gases from the waste site, and periodic maintenance to maintain the closure covering. Previous efforts to close such sites involved overlaying the site with an earthen soil layer. High water flow however, erodes soil covering, and vegetation providing resistance to erosion, requires cutting and growth control. Further, high water flow may require installation of benches around the perimeter of the side spaced, for example, typically at 100 feet to 150 feet intervals, to minimize soil erosion. The benches are substantially leveled broad interruptions or steps in the slope and extend along a contour. The bench typically includes a guttering system, or down chutes, for receiving water flow from the slope and channel the water to a catch basin for storage, treatment if any, and discharge to a water system or waterway. The bench may also provide a roadway for vehicles to move along the sloped ground.

In recent years, large area sites are closed with covering formed with elongated sheets of an impermeable geomembrane. The geomembrane seals the site from inflow of wind and water such as from rain and snow, and thereby prevents wastes and contaminates from infiltration into streams and ground water. The membranes often must be secured with anchors and trench systems to resist wind uplift. However, it is disfavored to use vertical anchors or rods that pierce the geomembrane, to prevent openings that may allow water flow into the underlying fill materials in the waste site. Alternatively, the membranes are covered with a soil layer, typically about 2 feet depth, to provide wind uplift protection and support natural vegetation. However, such vegetation then requires period servicing and maintenance.

To provide aesthetics and water flow control, tufted geotextiles have been overlaid on exposed membranes. Our prior U.S. Pat. No. 8,403,597 discloses a cover system for waste sites effective in resisting wind uplift and remaining in-place with frictional contact between the geomembrane and the geotextile and describes a synthetic underlying geomembrane for water drainage without erosion of an infill within interstices of the tufted tuft. The tufted geotextile provides a field of synthetic grasses with short blades extending from the geotextile backing sheet. In such installations, granular material infill may fill interstices of the tufts. The granular material assists with loading to resist wind uplift, filters water flowing through the geotextile into a synthetic drainage on the geomembrane, and assists with reducing exposure of the geotextile to UV and deterioration. The infill also provides for drivability of vehicles over the cover system.

The infill however is subject to displacement or movement from loading forces on the tufted geotextile. These loading forces include hydraulic (water flow), wind, seismic vibrations, subgrade materials creating vibrations or movement arising from materials degradation and decay, expansion and contraction loading of the tufted geotextile in response to thermal changes, and the like other loading forces directed onto the ground cover system. Displacement or movement creates areas of thin infill coverage and of thicker infill coverage. The infill must be maintained, and it is preferable for the infill to be uniform across the tufted geotextile.

While meeting closure system needs in the industry, there are opportunities for reduced costs in materials and maintenance while increasing longevity of the installed cover. A tufting gauge that spaces lines of tufts apart a greater distance than a smaller gauge provides fewer tufts per area while having reduced materials costs. However, the larger tufting gauge provides a larger gap between adjacent tufts, which gap allows for infill displacement or granular flow. The water flow creates hydraulic shear loading and may cause the granular infill material to be displaced and move, and thus require periodic maintenance to replace infill in areas that the infill has thinned. While hydraulic loading forces are typically more frequent events, there are also other loading forces may induce infill displacement including seismic events, ground vibrations, cover expansion and contractions (wrinkles in the tufted geotextile may be generated), and wind. Further, large outdoor landfill sites are often steeply sloped sites and geotextile/geomembrane stretching may create drum effects that dislodge infill (i.e., dry flow, displacement or movement of granular infill).

There are alternatives that reduce infill movement (i.e., increase infill shear resistance). While these have benefits as to maintenance for installed systems, increased tuft gauge and reduced tuft blade lengths have the countering drawbacks of reduced friction resistance of the tufted geotextile and geomembrane that restricts applications to less steeply sloped installations due to reduced friction resistance increases slip conditions. However, a uniform infill thickness across the installed cover enables a consistent water head that drives the rainfall water flow through the geotextile faster yet with a smaller drainage profile and increasing drainage length.

Further, the infill displacement tends to increase UV exposure and lead to degradation of the backing sheet of the tufted geotextile covering, and thus reduce the operational life for a tufted geotextile cover or a closure system for waste sites.

The need for benches also incurs installation and maintenance costs. The cover systems also typically involve the use of motor vehicles over the installed cover system for inspection and maintenance purposes. The overlaid tufted geotextile/geomembrane system with infill such as a sand thus preferably accommodates use of motor vehicles while resisting cutting and trenching and damaging the frictional interface that retains the geotextile overlaid on slopes of the covered landfill.

Accordingly, there is a need in the art for a ground cover tufted geotextile for containing infill with transverse diverter tufts providing increased resistance to infill displacement and granular flow movement in response to loading on the tufted geotextile during engagement to a ground surface or a geomembrane cover component. It is to such that the present invention is directed.

### SUMMARY OF THE INVENTION

The present invention meets the need in the art by providing an improved stitching pattern tufted geotextile for use with covering and closing waste sites and land surfaces that engages the ground surface or an underlying geomembrane cover component while providing shear resistance against infill movement and displacement caused by loading forces onto the ground cover. The tufted geotextile comprises a backing sheet tufted with a plurality of first tuft lines and a plurality of second tuft lines. Each one of the plurality of first tuft lines comprises a plurality of spaced-apart first tufts extending from a first side of the backing sheet. The first tufts form with a tufting yarn that defines a first yarn bridge of a first length on a second side of the backing sheet between a first tuft blade and a second tuft blade of adjacent first tufts. The plurality of first tufts are spaced-apart on a first tuft gauge. The plurality of second tuft lines each comprise a plurality of spaced-apart second tufts that extend from the first side of the backing sheet intermediate an adjacent pair of the first plurality of tuft lines. The second tufts form with a tufting yarn that defines a second yarn bridge of a second length on a second side of the backing sheet between a first tuft blade and a second tuft blade of second tuft. The second length for the second bridge is less than the first length first bridge. The second tufts are spaced-apart on a second tuft gauge, the second tuft gauge greater than the first tuft gauge. The plurality of first tufts define interstices between adjacent tufts. Upon installation, the tufted geotextile receives an infill of a granular material for filling the interstices from the first side of the backing sheet to a fill plane. The fill plane is less than a distal end of the blades of the tufts, whereby a distal end portion of the blades of the first tufts extend upwardly therefrom. The tufted geotextile ground cover system being overlaid on a surface to be covered and receiving the infill within the interstices, the second tufts resisting granular flow through the interstices in response to a loading force applied against the tufted geotextile ground cover system.

The tufted geotextile with lines of tufts and transverse intermediate tufts readily overlies a ground surface for covering purposes as well as installs as a component in a closure system that uses the geomembrane for shear resistance and impermeability for a land site such as a landfill, roadway foundation, backfill support for retaining walls, and other soil/waste site applications.

The tufted geotextile in accordance with the invention provides increased infill stability and resistance to displacement and movement, such as flow away caused by loading forces, for example but not limited to loading forces of water flow across the geotextile particularly during large hydraulic shear events on covered sloped ground surfaces experiencing water flow such as from rain storms and of wind, ground seismic vibrations, vibrations from degradations and decay of subsurface contents, and thermal movement of the geotextile, whereby the granular infill (typically sand or a sand mixture) remains stabilized on the geotextile and maintaining the geotextile as a ground cover secured to the ground surface or to a geomembrane below when used as a component of a cover system.

Further, unexpected and surprisingly the geotextile experiences increased frictional contact that resists geotextile creep movement and slippage relative to the surface on which the bottom surface of the geotextile contacts engagingly for surface covering purposes. This unexpected improved performance allows use of an alternate impermeable membrane in a composite covering system useful for long term ground site closure purposes. The geomembrane provides an impermeable barrier restricting inflow or seepage of water into the covered ground site. The alternate textured geomembrane may thereby be of lower cost for materials, manufacturing, and handling for installation than prior geomembranes, with a thinner cross-sectional thickness, and configured with opposing surface textured faces for selectively positioning to the ground surface and back surface of the geotextile, or with opposing faces having spikes or projections for engaging the ground surface and the backing sheet. The texturing of the textured face may be a surface scarring treatment (i.e., defining grooves and ridges) or a field of projecting stubs or peaked tapered spike or pins, which engage the warp portions of the tufting yarns on the bottom surface of the geotextile backing sheet for increased frictional engagement between the tufted geotextile and the geomembrane and/or the ground surface. Generally, a smooth surface geomembrane is less preferable as lacking dimensional stability, without a significant cost differential, and less drainage capacity.

Further, the tufted geotextile exhibits surprising increased time of concentration of water flow during hydraulic shear events with reduction in water flow velocity and shear across the tufted geotextile and increased flow through the permeable backing sheet either into the ground below or in a composite system with an impermeable geomembrane ground cover for flow below the tufted geotextile to drainage.

The interstices of the tufts in the geotextile of the present invention create tufted cells that maintain a selected thickness of the sand (or granular) infill with resistance to displacement, and contributes to a uniform driving head on the infill while increasing drainage critical length for water flow across the cover system. The geotextile in accordance with the present invention facilitates load force transmissivity within the infill trapped in the tuft cells with increased drainage critical length.

The tufted geotextile as recited above, in which the backing sheet has a basis weight of about 2 ounces per square yard to about 40 ounces per square yard.

The tufted geotextile as recited above, in which the backing sheet has a basis weight of about 2 ounces per square yard to about 6 ounces per square yard. The tufted geotextile as recited above, in which the backing sheet has basis weight of about 3 ounces per square yard.

The tufted geotextile as recited above, in which the backing sheet comprises a single-sheet backing sheet or alternatively, two or more backing sheets tufted together with polymeric yarns for defining the tufts extending from a surface of the first backing sheet.

The tufted geotextile as recited above, comprising at least two backing sheets each of about 6 ounces per square yard and a plurality of yarns tufted through the backing sheets to define spaced lines of tufts of simulated blades of grass extending from a surface, which yarns are about 20 to 21 ounces per square yard.

The tufted geotextile as recited above, in which the backing sheet comprises a first backing sheet and a second backing sheet tufted together with polymeric yarns for defining the tufts extending from a surface of the first backing sheet.

The tufted geotextile as recited above, wherein the first backing sheet and the second backing sheet each have a basis weight totaling about 2 ounces per square yard to about 60 ounces per square yard.

The tufted geotextile as recited above, wherein the first backing sheet and the second backing sheet each have a basis weight of about 2 ounces per square yard to about 80 ounces per square yard.

The tufted geotextile as recited above, in which the backing sheet comprises one or more backing sheets tufted together with polymeric yarns for defining the tufts extending from a surface of a first one of the backing sheets.

The tufted geotextile as recited above, wherein the polymeric yarns include UV resistant additives.

The tufted geotextile as recited above, wherein the yarns for the backing sheet includes UV resistant additives.

The tufted geotextile as recited above, wherein the polymeric yarns for the backing sheet include fire resistant additives.

The tufted geotextile as recited above, wherein the polymeric yarns for the tufts include fire resistant additives.

The tufted geotextile as recited above, wherein the tufts in the adjacent rows have blades of a first length in a first row and of a second length in an adjacent row, in which the first length is greater than the second length, which system provides for increased density yet reduces materials costs.

In another aspect, the present invention meets the need in the land site coverage art by providing a cover system with high shear resistance to infill displacement and granular dry flow, comprising a geomembrane providing an impermeable barrier overlying a ground surface and the synthetic grass tufted geotextile cover sheet described above, provided together as a composite ground cover. The combination geomembrane and tufted geotextile readily overlies a ground surface for covering purposes as well as installs as a closure system that uses the geomembrane/geotextile interface for shear resistance for a land site such as a landfill, roadway foundation, backfill support for retaining walls, and other soil/waste site applications. The interstices receive the infill, whereby the extending blades cooperatively with the infill, shadow the interstices from the geotextile to proximate the fill plane from UV exposure and resisting granular infill displacement in response to shear loading including water flow and dry granular flow of infill resulting from wind, seismic, internal vibrations, thermodynamics of the synthetic geotextile (and geomembrane in composite systems) that results in wrinkles in the cover.

### BRIEF DESCRIPTION OF THE DRAWINGS

FIG. 1 illustrates in perspective view a tufted geotextile having resistance to infill movement and displacement upon installation in overlying covering relation to a ground surface in accordance with the present invention.

FIG. 1A illustrates in detailed cross-sectional view a portion of the tufted geotextile shown in FIG. 1 taken on line 1A-1A.

FIG. 1B illustrates in detailed cross-sectional view a portion of the tufted geotextile shown in FIG. 1 taken on line 1B-1B.

FIG. 2 illustrates in bottom plan view the stitching pattern of the tufted geotextile shown in FIG. 1 for disposing tufts in the second tuft lines intermediate a pair of adjacent first tuft lines with an edge portion overlapped to show the extending tufts.

FIG. 3 illustrates in exploded cross-section elevational view an alternate embodiment having first and second backing sheets tufted with yarns.

FIG. 4 illustrates in cross sectional view a slope covered by the geotextile shown in FIG. 1.

FIG. 5 illustrates in cross sectional view a slope covered by a composite ground cover system of a water impermeable geomembrane and the geotextile shown in FIG. 1.

### DETAILED DISCUSSION

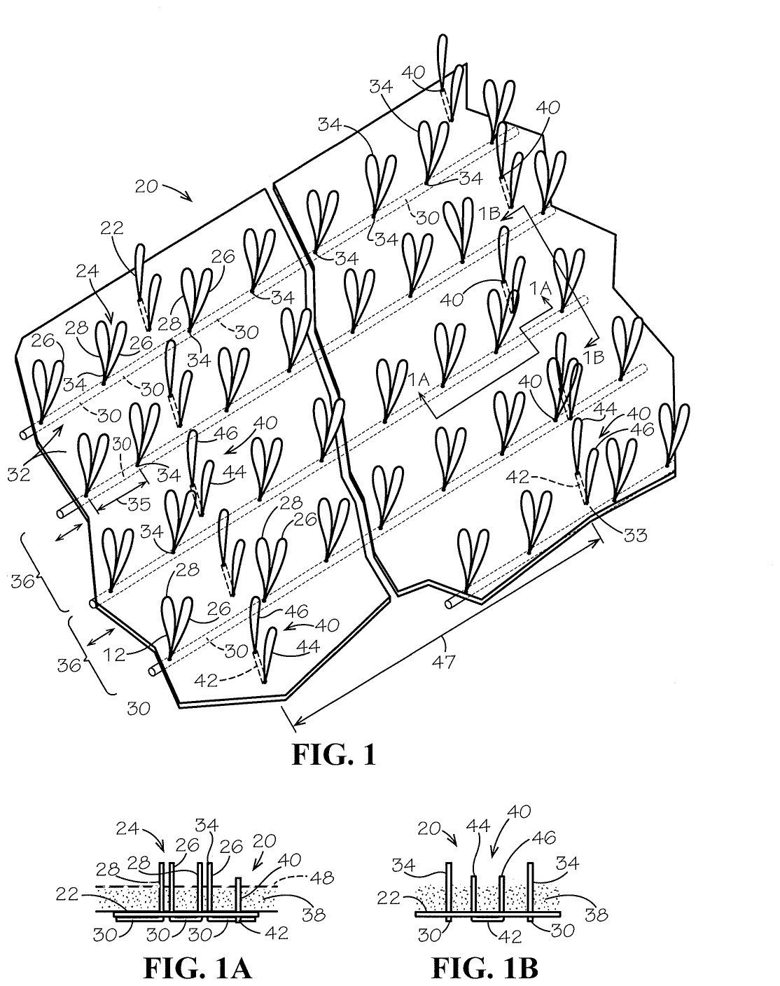

With reference to the drawings, in which like parts have like identifiers, FIG. 1 illustrates in perspective view a tufted geotextile 20 in accordance with the present invention. The tufted geotextile 20 comprises a backing sheet 22 holding a plurality of tufts generally 24 that extend as grass-like blades (for example, elongated thin narrow ribbon-like elements of a synthetic yarn) from an upper surface of the backing sheet.

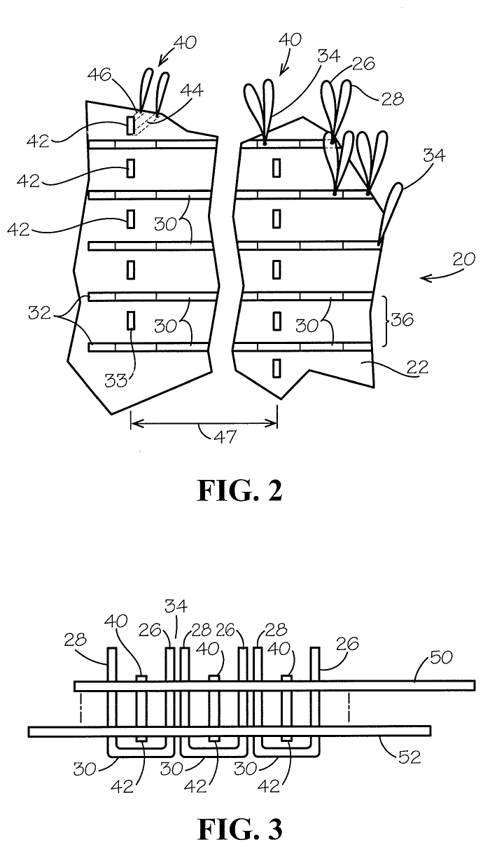

The tufted geotextile 20 of the present invention provides the tufts 24 in the backing sheet 22 in a plurality of spaced-apart first tuft lines 32 and intermediate second tuft lines 33. Each first tuft line 32 includes a plurality of spaced-apart first tufts 34 that extend as simulated grass blades from a first side of the backing sheet 22. The first tufts 34 form with a polymeric yarn that define a yarn bridge 30 of a first length across a portion of the bottom surface of the backing sheet 22 (as also shown in bottom view in FIG. 2). The yarn extends from the upper surface as the first blade 26 and the opposing second blade 28. Each tuft 34 in the illustrated embodiment comprises the first blade 26 from a first bridge 30 and the second blade 28 of an adjacent bridge, as shown in cross-sectional elevational view in FIG. 1A. The first tufts 34 in the line 32 are spaced-apart on a first tuft gauge 35. The first tuft gauge 35 may be between ⅛ inch and 1 inch, preferably ¼ inch to ¾ inch, and more preferably, about ½ inch. The tuft lines 32 are spaced-apart between ¼ and 1 inch, preferably ½ inch, and define interstices 36 therebetween. The tufts 34 extend a length from the backing sheet. The length is from about ½ inch to about 4 inches. As discussed below, the interstices 36 may preferably receive an infill 38 of a particulate material.

With continuing reference to FIGS. 1 and 2, the plurality of second tuft lines 33 each comprise a plurality of spaced-apart second tufts 40 that extend as simulated blades of grass from the first side of the backing sheet 22 intermediate an adjacent pair of the first plurality of tuft lines 32. The second tufts 40 similarly form with a polymeric yarn. The yarn defines a second yarn bridge 42 of a second length on the bottom side of the backing sheet 22. The length of the second bridge 42 is preferably less than the spacing of the adjacent lines 32, so that the second tuft 40 is disposed intermediate respective opposing adjacent ones of the first tuft lines 32. The second yarn bridge 42 has a longitudinal axis oriented an angle to the first tuft lines 32, which angle is preferably transverse or perpendicular to the first tuft lines. As also shown in cross-sectional elevational view in FIG. 1B, the yarn extends from the first surface of the backing sheet as a first tuft blade 44 and a second tuft blade 46. The tuft lines 33 are spaced-apart on a second tuft gauge 47 that is greater than the first tuft gauge 35. The tuft gauge 47 spaces the tuft lines 33 apart from about ¼ inches to about 24 inches. The tuft gauge 47 is generally about a drainage length provided by a predetermined uniform distribution of the infill 38 in the interstices 36 for a hydraulic head for flow of water over the cover system. The tufts 40 extend a length from the backing sheet 22. The length is from about ½ inch to about 4 inches. The tufts 40 may be of a length that is less than the length of the tufts 34. This reduces material costs of the tufted geotextile while maintaining the diverting structure of the intermediate tufts 40 disposed in the interstices 36, as discussed below.

As noted above, the tuft lines 32 define interstices 36 that are extended channels between adjacent first tufts 34. The second tufts 40 occupy a diverting position within the channel of the interstices 36 intermediate adjacent tuft lines 32. Upon installation of the ground cover system overlying a ground surface, the interstices 36 receive the infill 38 of a particulate granular material. The infill 38 fills the interstices 36 from the first side of the backing sheet 22 to a fill plane 48. The height of the fill plane 48 is generally less than a length from the backing sheet 22 to a distal end of the blades of the tufts 34. A distal end portion of the blades of the tufts 34 preferably extend upwardly through the infill. The fill plane 48 may be proximate a distal end of the intermediate tufts 40. In an alternate embodiment, the height of the fill plane 48 is less than the length of a tuft 40. The tufted geotextile ground cover system 20 being overlaid on a surface to be covered and receiving the infill within the interstices 36, the second tufts 40 resist granular flow of the infill 38 through and along the interstices in response to a loading force applied against the tufted geotextile ground cover system. The infill provides a hydraulic head for flow of water within the infill across the cover system and through the backing sheet 22. A predetermined uniformly thick layer of infill provides a consistent drainage length for the water flow in the infill. As noted above, the tuft gauge 47 may be designed for about a drainage length provided by a predetermined uniform distribution of the infill 38 in the interstices 36 for a selected hydraulic head for flow of water over the cover system. Displacement or movement of the infill however interferes with predetermined water flow for a particular ground site, and the present invention of intermediate diverter tufts resist infill displacement or movement.

### The Backing Sheet

The backing sheet 22 in the illustrated embodiment is woven with warp and weft yarns, although a nonwoven sheet may be used. The backing sheet 22 has a weight basis or mass of between about 2 ounces per square yard to about 40 ounces per square yard. The tufted geotextile 20 may comprise one or more backing sheets. In the embodiment illustrated in exploded view in FIG. 3, the backing sheet 22 comprises a first backing sheet 50 and a second backing sheet 52. The tufting yarns extend through the backing sheets 50, 52 to secure the backing sheets closely together with the spaced-apart rows 32, 33 of tufts that extend from the geotextile 20 as the grass-like blades 26, 28 and 44, 46. The blades extend from the backing sheet 22 about ½ inch to about 4 inches, and more preferably from about 1 inch to about 1 and ½ inches. The blades 44, 46 may be of a length different from the length of the blades 26, 28, and preferably are of a shorter length and preferably about the height of the fill plane 48 for the infill 38. The adjacent tufts 34 define the interstices 36 that receive the granular infill 38 selectively to the fill plane 48.

The grass filaments or blades formed by the tufting yarns preferably have an extended operational life of at least about 50 years to about 100 years. The yarns for the tufts of synthetic grass blades are preferably polyethylene or polypropylene, or other polymeric.

The backing sheet 22 (or 30, 32) form of a polymer material that resists exposure to sunlight that generates heat rise in the geotextile 20 and that resists ultraviolet (UV) radiation in the sunlight, which degrades the backing sheet and the tufted blades. The polymer yarns further should not become brittle when subjected to low temperatures. The color selection of the yarns for the backing sheet 22 are preferably black and/or gray yarns. The color selection for the tufting yarns are green or brown, to simulate grasses. The tufts may be tufted in combinations for closer simulation of the area to be covered, for example using a respective proportion of a first, second, or more, color yarns. Further, the polymeric material for the yarns that are woven to form the backing sheet or the polymers spun bond for a non-woven backing sheet, include UV resistant additives such as HALS and carbon black. The polymers are selected to provide high shear strength resistance for the geotextile 20. The backing sheet has strong tensile strength, in a range of about 800 pounds per foot to about 4,000 pounds per foot.

### Cover System for Landfill and Waste Site Closure

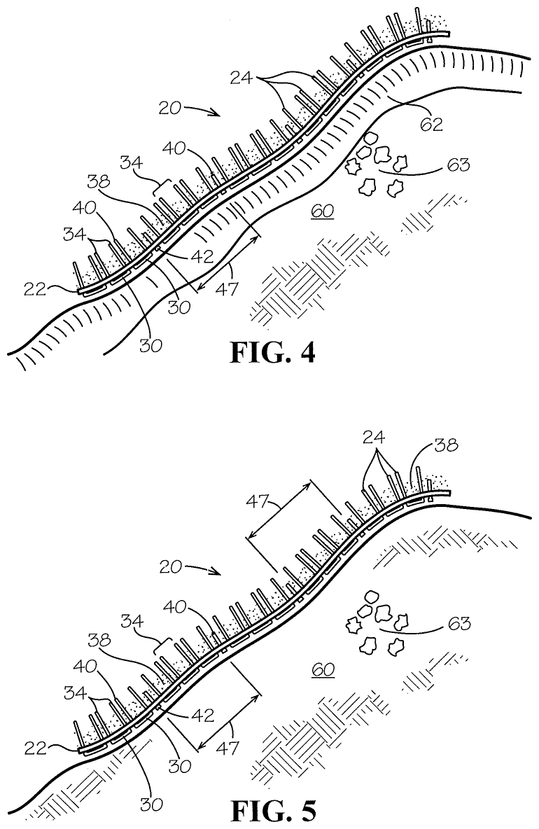

With reference to FIG. 4, the tufted geotextile 20 readily installs as a cover system for overlying a land site 60 with the bottom of the backing sheet 22 and the bridges 30, 42 in frictionally engaging contact with a ground surface or a geomembrane overlying the ground surface. The illustrated land site 60 may include a soil overlayment layer 62 that covers waste materials 63 such as in a landfill. In an alternate embodiment, the tufted geotextile 20 may gainfully use the granular infill 38 received within the interstices 36 between the tufts 24 of the backing sheets 22 (50, 52). The infill 38 is a granular material cooperating with the extending blades of the tufts 24 to shadow the backing sheet 22 while providing a mass that resists wind uplift of the geotextile and provides hydraulic head for water flow over and through the geotextile 20. The infill 38 fills onto the backing sheet 22 within the interstices 36 to about a second extent or fill plane 48 of the geotextile. The infill 38 cooperates with the blades 36 to shadow the backing sheet 22 from UV exposure and degradation.

The infill 38 may be a sand material, and further particularly may comprise a fire retardant additive or product independent of a sand carrier mixture, such as a non-halogenated magnesium hydroxide powder, silicates including potassium silicate, calcium silicate, and sodium silicate, or other in situ fire suppression or resistant material.

The tufting pattern of the geotextile 20 in accordance with the invention provides high shear resistance to displacement or movement of the infill 38 arising from loading on the geotextile. Loading arises from, for example, hydraulic shear forces of water flow across the geotextile such as caused by rain storms over the covered land site. High flow tends to dislodge and displace the infill. In the present invention, the intermediate tufts 40 divert and disrupt water shear flow. This increases water flow time of concentration and increases the flow drainage length in the channel, which water flow is slowed by the intermediate tufts 40 in the interstices 36. The water flow passes less turbulently through the infill 38, and through the porous backing sheet 22. The water may then enter into the soil below the geotextile 20, or when used in a covering system for closure purposes of a land site flow over an impermeable geomembrane (discussed below) disposed below the geotextile for flow to a collection channel downslope. The tufted geotextile 20 thereby resists displacement of the infill 38 arising from hydraulic shear forces of water flow over the steep slopes (such as 2V:1H or more steeply sloped surfaces as may be present in a landfill), such that the granular loose infill 38 remains as placed in the interstices 36 even without a securing material such as cementitious granules that cure in place. Further, the tuft pattern of the geotextile 20 resists dry flow loading forces that can result in infill displacement and movement. These loading forces include geotextile movement arising from thermal expansion and contraction (wrinkles) causing infill displacement or movement, wind flow and infiltration that displaces infill or carries air-borne infill away, subsurface ground (seismic) vibrations, and ground site contents settlement and vibrations (contents decay and degradation that may open subsurface voids filled by elevated content movement).

### Geotextile and Geomembrane Closure System

With reference to FIG. 5, the geotextile 20 readily installs alternatively with a water impermeable geomembrane 70 for a closure covering system 72 for landfills and waste sites. These sites typically have steep slopes from a toe 74 to an apex 76, and may have slopes of up to about 45 degrees (2V:1H, or greater) with elevational differences of 200 feet or more. The geotextile 20 of the present invention readily installs for site covering or closure purposes without benches intermediate the toe 74 and apex 76, although benches may be employed.

The geomembrane 70 positions with a first surface overlying a land surface. The tufted geotextile 20 then overlies the geomembrane. Alternatively, the cover system may install as a component assembly. The geomembrane 70 provides a frictional interface or a mechanical interface with the ground surface resistant to shear or sliding forces. The geomembrane 70 may have textured surfaces and/or extending projections such as structural drainage features on opposing surfaces. The bridges 30, 42 frictionally engage the texture or the projections of the geomembrane to resist movement of the geotextile relative to the geomembrane while the intermediate tufts 40 resist displacement or movement of the infill 38 as discussed above.

Further, applications of the disclosed cover system using infill 38 experiences increased resistance to shear forces for reducing hydraulic displacement and dry flow movement of the infill 38 particularly on steeply sloped sites. The penetration of the geomembrane projections into, or textured surface engagement with, the geotextile 20 form a mechanical connection between the geomembrane 50 and the geotextile 20. The interface resistance to slippage is based upon the material strength of the geotextile and the projections in combination with the transverse pattern of the bridges 30 and 42. The present invention provides high shear strength for a geotextile in a variety of applications including soil coverage and as a component of a closure system having the geomembrane and the geotextile to the resist slippage of the tufted geotextile relative to the geomembrane in response to hydraulic shear loading on the cover system. The tufting structure of the geotextile further resists dry flow forces that can result in movement of the geotextile (wrinkles) or displacement of the infill.

The interstices between the tufts in adjacent ones of the first lines of tufts become elongated paths for flow of water across the tufted geotextile. The water flow may, depending on a surface grade or slope on which the tufted geotextile is overlaid and on environmental water volume from rainfall on to the tufted geotextile, become turbulent with high hydraulic sheer and cause displacement of infill. Displacement leads to covered areas with little or no infill while other areas have significant over-coverage of infill, or infill is lost by being carried away in turbulent water flow or airborne in winds. In the present invention the tufts of the second lines of tufts form longitudinally-spaced structures or “divergers” in the channels intermediate the adjacent ones of the first lines of tufts. The divergers partially block the channels and cause the water flow to slow and result in an increase in time of concentration. Reduced water flow and increased time of concentration reduces infill displacement increased drainage critical length.

Further, the second line of tufts being tufted in the second direction increase the friction engagement of the tufted geogtextile with the ground surface over which the tufted geotextile is placed or with the geomembrane in a closure covering system for a land site. The tufted geotextile is less susceptible to slippage and creep due to the intersecting frictional forces between the bridges of the first and second lines of tufts with the ground or with the geomembrane, thereby increasing the covering stability and decreasing wear forces that lead to shortened covering life period for the tufted geotextile and the land site covering system. An extended service life for the tufted geotextile reduces the per-year allocated cost of materials and installation while reducing costs and labor for maintaining the covering system during its operational service life.

The foregoing discloses a geotextile having increased resistance to infill displacement and movement in response to loading on the geotextile, said displacement causing loss of infill and creating both thin or bare portions and over-fill portions of the cover system requiring periodic maintenance without the use of securing additives such as cement, with increased frictional engagement of the geotextile to underlying surfaces and reduced materials costs.

In the closure application, the geotextile secures in a first embodiment with the frictional interface to the geomembrane or secures in a second embodiment with the mechanical engagement.

The features disclosed for the improved geotextile lead to increased usage longevity in land site covering and closure system applications with increased shear resistance to displacement of infill while providing water flow control, and resistance to UV and heat degradation (including in alternate embodiment a waste sheet for initial term degradation protecting a second backing sheet), for long term covering and closure of land sites.

What is claimed is:

1. A tufted geotextile ground cover system, comprising:
a backing sheet tufted with
a plurality of first tuft lines
each one of said plurality of first tuft lines comprising a plurality of spaced-apart first tufts extending from a first side of the backing sheet, said first tufts formed by a tufting yarn that defines a first yarn bridge of a first length on a second side of the backing sheet between a first tuft blade and a second tuft blade of adjacent first tufts,
said plurality of first tufts spaced-apart on a first tuft gauge, and
a plurality of second tuft lines,
each one of said plurality of second tuft lines comprising a plurality of spaced-apart second tufts extending from the first side of the backing sheet intermediate an adjacent pair of said first plurality of tuft lines, said plurality of second tufts formed by a tufting yarn that defines a second yarn bridge of a second length on a second side of the backing sheet between a first tuft blade and a second tuft blade of adjacent second tufts, said second length less than said first length, and
said plurality of second tufts spaced-apart on a second tuft gauge, the second tuft gauge greater than the first tuft gauge;
the plurality of first tufts defining interstices between adjacent tufts;
an infill of a particular granular material for filling the interstices from the first side of the backing sheet to a fill plane, the fill plane less than a distal end of the blades of the tufts, whereby a distal end portion of the blades of the first tufts extend upwardly therefrom; and
whereby the tufted geotextile ground cover system being overlaid on a surface to be covered and receiving the infill within the interstices, the second tufts resisting granular flow through the interstices in response to a loading force applied against the tufted geotextile ground cover system.

2. The tufted geotextile ground cover system as recited in claim 1, wherein said second yarn bridges are oriented angularly transverse between respective adjacent first tuft lines, wherein the second yarn bridges provide for frictional engagement with a surface below the backing sheet.

3. The tufted geotextile ground cover system as recited in claim 1, wherein said second yarn bridges are oriented substantially perpendicular to the respective adjacent first tuft lines,
whereby the second yarn bridges provide for frictional engagement with a surface below the backing sheet.

4. The tufted geotextile ground cover system as recited in claim 3, wherein the surface below the backing sheet comprises a ground surface.

5. The tufted geotextile ground cover system as recited in claim 3, wherein the surfaced below the backing sheet comprises a geomembrane.

6. The tufted geotextile ground cover system as recited in claim 1, further comprising a geomembrane that defines a fluid impermeable layer for overlying a ground surface for covering by the tufted geotextile ground cover system.

7. The tufted geotextile ground cover system as recited in claim 1, wherein the first tuft gauge is about ½ inch.

8. The tufted geotextile ground cover system as recited in claim 5, wherein the second tuft gauge is between about 4 inches and 24 inches.

9. The tufted geotextile ground cover system as recited in claim 1, wherein the first and second blades of the first tufts extend from the backing sheet a first blade length in a range of about ½ inch to about 4 inches.

10. The tufted geotextile ground cover system as recited in claim 9, wherein the first and second blades of the second tufts extend from the backing sheet a second blade length from a range of about ½ inch to about 4 inches.

11. The tufted geotextile ground cover system as recited in claim 9, wherein the second blade length is less than the first blade length.

12. The tufted geotextile ground cover system as recited in claim 9, wherein the second blade length is about that of the fill plane.

13. A ground cover system, comprising:
an impermeable geomembrane for overlying a ground surface;
a backing sheet tufted with
a plurality of first tuft lines
each one of said plurality of first tuft lines comprising a plurality of spaced-apart first tufts extending from a first side of the backing sheet, said first tufts formed by a tufting yarn that defines a first yarn bridge of a first length on a second side of the backing sheet between a first tuft blade and a second tuft blade of adjacent first tufts,
said plurality of first tufts spaced-apart on a first tuft gauge, and
a plurality of second tuft lines,
each one of said plurality of second tuft lines comprising a plurality of spaced-apart second tufts extending from the first side of the backing sheet intermediate an adjacent pair of said first plurality of tuft lines, said plurality of second tufts formed by a tufting yarn that defines a second yarn bridge of a second length on a second side of the backing sheet between a first tuft blade and a second tuft blade of adjacent second tufts, said second length less than said first length, and
said plurality of second tufts spaced-apart on a second tuft gauge, the second tuft gauge greater than the first tuft gauge;
the plurality of first tufts defining interstices between adjacent tufts;
an infill of a particular granular material for filling the interstices from the first side of the backing sheet to a fill plane, the fill plane less than a distal end of the blades of the tufts, whereby a distal end portion of the blades of the first tufts extend upwardly therefrom; and
whereby the tufted geotextile ground cover system being overlaid on a surface to be covered and receiving the infill within the interstices, the second tufts resisting granular flow through the interstices in response to a loading force applied against the ground cover system.
